(19) United States
(12) Patent Application Publication
(10) Pub. No.: US 2006/0218649 A1
(43) Pub. Date: Sep. 28, 2006

(54) Method for conditional disclosure of identity information

(76) Inventors: Ernie F. Brickell, Portland, OR (US); Matthew D. Wood, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/088,548

(22) Filed: Mar. 22, 2005

(51) Int. Cl. H04L 9/32

(52) U.S. Cl. 726/27

(57) ABSTRACT

Providing conditional access to a unique device identifier (ID) stored in a device in a processing system may be accomplished by determining if a platform state (such as firmware and/or data) is present in a non-volatile storage of the processing system; when the platform state is not present, loading the device ID into a volatile storage of the processing system, receiving a request from an external entity to obtain the device ID, sending the device ID to the external entity, and rejecting all subsequent requests to obtain the device ID; and when the platform state is present, rejecting all requests to obtain the device ID.

### BACKGROUND

1. Field

The present invention relates generally to computer security and, more specifically, to privacy protection for users of a processing system by ensuring conditional access to identity information.

2. Description

It is often desirable to protect the privacy of a user of a processing system. When the processing system includes one or more devices having unique identifying information stored therein, open access to that information may give rise to a privacy concern. Thus, it is typically desirable to deter or prevent unfettered access to the uniquely identifying information stored in a device by other entities within or outside the processing system.

### BRIEF DESCRIPTION OF THE DRAWINGS

The features and advantages of the present invention will become apparent from the following detailed description of the present invention in which:

FIG. 1 is a diagram of an example provisioning system according to an embodiment of the present invention;

FIG. 2 is a flow diagram illustrating controlling access to identity information according to an embodiment of the present invention; and

FIG. 3 is a diagram of another example provisioning system according to an embodiment of the present invention.

### DETAILED DESCRIPTION

An embodiment of the present invention is a method of providing conditional access to unique identifying information stored in a device of a processing system. For privacy reasons, it is desirable to deter unique identifying information attached to hardware devices from being freely available to other entities within or outside the processing system. Embodiments of the present invention prevent exposure of a device's unique identifying information unless a true need for the information exists on the processing system, and limit the exposure of the information when the need exists. Such embodiments allow for provisioning of one or more cryptographic keys to the processing system during run-time with sufficient constraints to deter a privacy breach in the field.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

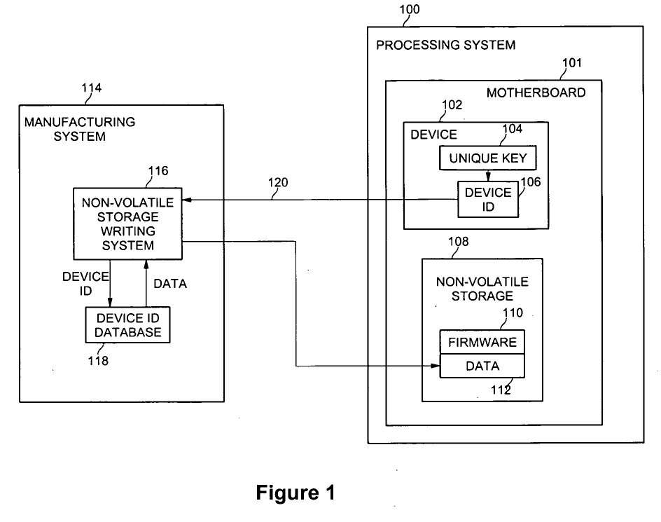

FIG. 1 illustrates an example provisioning system in accordance with an embodiment of the present invention. Processing system 100 comprises any system for computing data, such as a personal computer (PC), an engineering workstation, a mainframe computer, a server computer, a handheld computer, a personal digital assistant (PDA), a cell phone, a set-top box, and the like. Processing system includes one or more processors, communications buses, and other components as is well known in the art, all of which are omitted from FIG. 1 for clarity. Processing system 100 includes a motherboard 101 having at least one device 102 for performing a function for the processing system. For example, the device may be a logic device for controlling other devices in the processing system, such as a device commonly known as a chipset (memory controller hub). Other logic devices may also be used. In one embodiment, the device may include logic for performing various functions, but may have no internal random access memory (RAM) or read only memory (ROM) for storing cryptographic keys or other data. The device may include at least one unique key 104, and a device identifier (ID) 106. In one embodiment, the device ID may be generated from the unique key. In an embodiment, the unique key and the device ID may be represented within the device hardware (i.e., “hard wired” or “hard coded”) according to known methods. The unique key and device ID may be set within the device during manufacturing of the device by a device manufacturer. The unique key and the device ID may be used for cryptographic processing by the device within the processing system.

The processing system may also include non-volatile storage 108 on the motherboard 101, for storing instructions and information such as firmware 110 and data 112. In one embodiment, the non-volatile storage comprises an electrically erasable read only memory (EEPROM). The firmware (such as a Basic Input Output System (BIOS), for example) may be used by the processing system to “start up” and initialize the components of the processing system.

In at least one scenario of usage of the processing system, it may be desirable for the device ID to be accessed when provisioning the processing system during system manufacture. That is, initialization of cryptographic processing for the processing system during manufacturing of the processing system may require usage of the device ID, for example. However, it may also be desirable to limit access to the device ID thereafter (i.e., further in the manufacturing process or when the processing system is in the field), since the device ID may be used to uniquely identify the processing system. Embodiments of the present invention provide conditional access to the device ID to promote the protection of privacy for an eventual user of the processing system. Initialization of cryptographic processing for the processing system may include storage of data 112 in an encrypted format in the non-volatile storage for later use.

Since the non-volatile storage 108 requires special writing equipment (such as a EEPROM “burner” for example), writing to the non-volatile storage may be done at time of manufacture of the processing system, and is not typically done by a user of the processing system. Manufacturing system 114 may include non-volatile storage writing system 116, and a device ID database 118. In one embodiment, the manufacturing system may be operated by a processing system manufacturer.

During provisioning of the processing system as part of the manufacturing process, when the device is reset (by either an initial “power up” or a subsequent reset) at the direction of the manufacturer or manufacturing system, the device typically enters a state where the device performs a set of self-checks and synchronizes itself with other components of the processing system. In this state, in one embodiment of the present invention, the device determines whether a platform state is present in the non-volatile storage. In one embodiment, the platform state comprises having specific firmware 110 and/or specific data 112 present in the non-volatile storage. In other embodiments, other indicators of platform state may be used. If the firmware and specific data are already present in the non-volatile storage, then the device does not make the device ID available in any storage that may be read external to the device. If the firmware and data are not yet present, the device allows the device ID to be read by another system component one time only. In one embodiment, this may be accomplished by writing the device ID into a register (not shown) or other volatile storage (not shown) in the processing system. The device ID is then allowed to be extracted from the device exactly once per reset.

In FIG. 1, the extraction of the device ID is represented by line 120. In one embodiment, the non-volatile storage writing system obtains the device ID from the device. After extraction, the device erases the device ID from the register or volatile storage and any additional attempts to obtain the device ID fail. Attempts to extract the device ID also fail if they are made before the present method described above is started. Thus, embodiments of the present invention provide for a single extraction of the device ID per power cycle to the device, for provisioning purposes, while preventing the device ID from being generally available for other uses.

Once non-volatile storage writing system 116 obtains the device ID, the non-volatile writing system interfaces with device ID database 118 to obtain specific data corresponding to the device ID, and stores this data in an encrypted format as data 112 into non-volatile storage 108 on the processing system. The device ID database 118 may contain entries mapping a device ID to associated data. In one embodiment, the data may comprise a cryptographic key (such as an attestation key, for example) for future use in cryptographic processing on the processing system, and the data may be encrypted with another key that is held in the device so that only the device can decrypt the data. In an embodiment, the size of the data may be larger than the size of the device ID. The encrypted data 112 stored in the non-volatile storage has been bound to the device, thus only the device can decrypt the encrypted data, and a subsequent user of the processing system cannot determine what the device ID is. In one embodiment, the data may comprise an authentication value for specific firmware. The authentication value may be tied to another key in the device, and used by the device to verify the authenticity of the specific firmware. In one embodiment, the data may comprise a cryptographic key that is used to decrypt specific firmware, and this cryptographic key may be further encrypted with another key in the device so that only the device can decrypt that data.

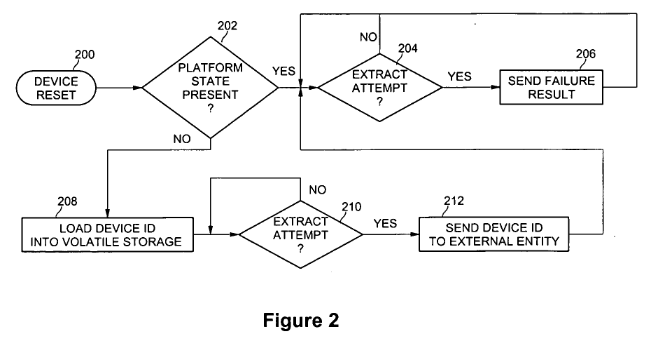

FIG. 2 is a flow diagram illustrating controlling access to identity information according to an embodiment of the present invention. At block 200, the device is reset. At block 202, a check is made by the device to determine if a platform state (such as specific firmware and/or specific data, for example) is already present in the non-volatile storage of the processing system. If the platform state (such as firmware 110 and/or specific data 112, for example) is present, the device enters a logic loop that will always return a failure result whenever an attempt is made to extract the device ID. Hence, at block 204, if an attempt is made to extract the device ID, a failure result may be sent at block 206 to the requesting entity (external to the device). Any further attempts to extract the device ID may also be handled in the same way. However, if at block 202, the platform state (e.g., firmware and/or data) is not yet present in the non-volatile storage, then at block 208 the device ID may be loaded into a register or other volatile storage and made available for access, and the device enters a state that waits for an attempt to extract the device ID by a requesting external entity. An external entity is any entity external to the device. When an attempt to extract the device ID is made by an external entity at block 210, the device sends the device ID to the requesting external entity at block 212. Once the device ID has been extracted once, the device ID may be deleted from the volatile storage and the device transitions to block 204. Any further attempts to extract the device ID without a device reset will result in a failure at block 206. Once the firmware (e.g. BIOS) and specific data are written to the non-volatile storage by the system manufacturer during provisioning of the processing system, all subsequent attempts to extract the device ID will fail. When the processing system is in the field, the firmware will be present in the non-volatile storage and any attempts to obtain the device ID will fail.

Although a particular sequence of steps is shown in FIG. 2, other steps may also be used to accomplish the same result and are within the scope of the present invention.

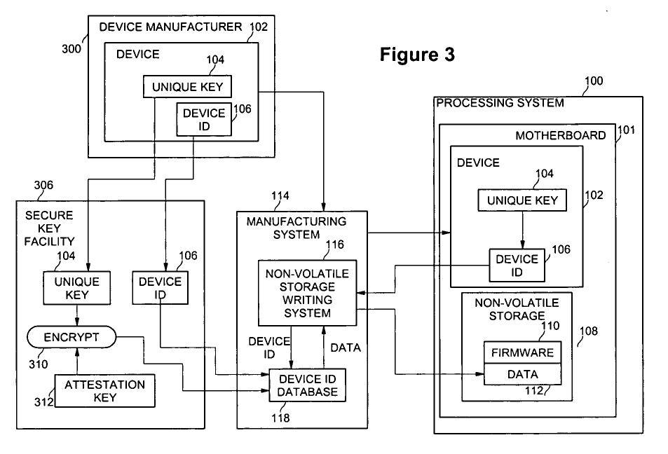

FIG. 3 is a diagram of another example provisioning system according to an embodiment of the present invention. In this embodiment, a device manufacturer 300 manufactures a device 102 having a unique key 104 hard-wired therein and requires that the device have a private signature key (called an attestation key) that has been certified by the manufacturer for use in subsequent cryptographic operations. For example, the device can use the private signature key to prove to another entity that the device is certified by the device manufacturer. In some scenarios, the device does not, however, have non-volatile storage to store the private signature key. In addition, in some embodiments, the private signature key may comprise a large number of bits, such as 1024, 2048, or 4096, for example, that may be larger than any available storage on the device. In one embodiment, the device may only be capable of storing a smaller (e.g., 128 bit) unique key 104 and a device ID 106 at the time of manufacture and the device manufacturer needs a way to identify the device in a privacy-friendly manner after the device has been placed in a processing system containing adequate non-volatile storage. In an embodiment, the unique key and device ID have a one-to-one mapping. The device manufacturer maintains a list of unique key and device ID values and securely transfers the list to the secure key facility. In one embodiment, the device manufacturer and the secure key facility may be integral.

A secure key facility 306 is responsible for generating device specific firmware and/or data. The secure key facility generates a unique attestation key 312. The secure key facility may use the unique key 104 to encrypt 310 the unique attestation key. The encrypted attestation key may be communicated to a manufacturing system 114 along with the device ID and stored in an entry in the device ID database 118 corresponding to the device ID 106 associated with the device 102. In this way, the encrypted attestation key may be correlated to the device. In another embodiment, the secure key facility builds the device ID database before sending the database to the manufacturing system. In one embodiment, the manufacturing system may be operated by an original equipment manufacturer (OEM) or other entity manufacturing a complete processing system. In another embodiment, the same entity may be manufacturing the device and the completed processing system. In that embodiment, the manufacturing system may be integral with the device manufacturer.

After the device has been distributed to the processing system manufacturer, the processing system manufacturer may desire to manufacture and provision the processing system. That is, the processing system manufacturer prepares the processing system for sale and/or distribution to a user. Using embodiments of the present invention, the device will release the device ID for a single access by the manufacturing system per reset according to the operations described with reference to FIG. 2. The manufacturing system may extract the device ID from the device embedded in the processing system, look up the entry in the device ID database 118 matching the obtained device ID, and obtain the associated stored encrypted attestation key 312. In this embodiment, the encrypted unique attestation key (bound to the device 102) may then be stored in the non-volatile storage 108 as data 112 for future cryptographic processing on the processing system 100. The manufacturing system 114 also stores the firmware 110 in the non-volatile system.

When the processing system is powered up or reset, the device may read the encrypted attestation key from non-volatile storage. The device can decrypt the encrypted attestation key because the device can generate its own copy of the store key from the unique key. The device may then use the attestation key for cryptographic processing.

Although the operations may be described herein as a sequential process, some of the operations may in fact be performed in parallel or concurrently. In addition, in some embodiments the order of the operations may be rearranged without departing from the spirit of the invention.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method of providing conditional access to a unique device identifier (ID) stored in a device in a processing system comprising:
determining if a platform state is present in a non-volatile storage of the processing system;
when the platform state is not present, loading the device ID into a volatile storage of the processing system that is available for external access; and
when the platform state is present, rejecting all requests to obtain the device ID.

2. The method of claim 1, wherein the making the device ID available for external access further comprises allowing at most one request for the device ID.

3. The method of claim 1, wherein the platform state comprises storage of at least one of firmware and data on the non-volatile storage, and at least one of the firmware and the data are written into the non-volatile storage after an external entity receives the device ID.

4. The method of claim 3, wherein the data comprises an encrypted cryptographic key associated with the device.

5. The method of claim 1, further comprising determining if the platform state is present each time the device is reset.

6. The method of claim 2, wherein the processing system sends the device ID only once, and deletes the device ID from the volatile storage after sending the device ID.

7. A device comprising:
a unique key; and
a device ID;
the device being configured to determine if a platform state is present in a non-volatile storage accessible by the device, when the platform state is not present, to load the device ID into a volatile storage, to receive a request from an external entity to obtain the device ID, to send the device ID to the external entity, and to reject all subsequent requests to obtain the device ID; and when the platform state is present, to reject all requests to obtain the device ID.

8. The device of claim 7, wherein the device is further configured to send the device ID only once, and to delete the device ID from the volatile storage after sending the device ID.

9. The device of claim 7, wherein the platform state comprises data having an encrypted cryptographic key associated with the device.

10. A processing system comprising:
a non-volatile storage capable of storing a platform state; and
a device having a device identifier (ID), the device being configured to determine if the platform state is present in the non-volatile storage, when the platform state is not present, to load the device ID into a volatile storage of the processing system, to receive a request from an external entity to obtain the device ID, to send the device ID to the external entity, and to reject all subsequent requests to obtain the device ID; and when the platform state is present, to reject all requests to obtain the device ID.

11. The processing system of claim 10, wherein the platform state comprises at least one of firmware and data, and the non-volatile storage stores at least one of the firmware and the data after the external entity receives the device ID.

12. The processing system of claim 11, wherein the data comprises an encrypted cryptographic key associated with the device.

13. The processing system of claim 10, wherein the device is configured to derive the device ID from a unique identifier hard wired in the device.

14. The processing system of claim 10, wherein the processing system is configured to send the device ID only once, and to delete the device ID from the volatile storage after sending the device ID.

15. In a manufacturing system, a method of provisioning a processing system for providing conditional access to a unique device identifier (ID) of a device of the processing system comprising:
resetting the device;
requesting the device ID from the device;
receiving the device ID from the device;
retrieving data associated with the device from a database; and
causing the storing of the data into non-volatile storage in the processing system.

16. The method of claim 15, wherein the data comprises an encrypted cryptographic key associated with the device.

17. A system comprising:
a processing system including
a non-volatile storage capable of storing a platform state;
a volatile storage; and
a device having a device identifier (ID), the device being configured to determine if the platform state is present in the non-volatile storage, when the platform state is not present, to load the device ID into the volatile storage, to receive a request to obtain the device ID, to send the device ID, and to reject all subsequent requests to obtain the device ID;
and when the platform state is present, to reject all requests to obtain the device ID; and
a manufacturing system configured to reset the device, to request the device ID from the device, to receive the device ID from the device, to retrieve data associated with the device from a database; and to cause the storing of the platform state into the non-volatile storage in the processing system.

18. The system of claim 17, wherein the platform state comprises at least one of firmware and data, and the data comprises an encrypted attestation key bound to the device.

19. The system of claim 17, wherein the device sends the device ID only once, and deletes the device ID from the volatile storage after sending the device ID.

20. The system of claim 18, further comprising a secure key facility, the secure key facility including encryption logic to encrypt a second key using the unique key, and being configured to store the device ID and the encrypted second key as the data associated with the device in an entry in the database.
